(19) United States
(12) Patent Application Publication
(10) Pub. No.: US 2026/0244470 A1
(43) Pub. Date: Aug. 20, 2026

(54) DEMONSTRATION-BASED TASK ASSISTANCE USING MACHINE LEARNING

(71) Applicant: Microsoft Technology Licensing, LLC, Redmond, WA (US)

(72) Inventors: Andrew D. WILSON, Seattle, WA (US); Vibhav VINEET, Bellevue, WA (US); Balasaravanan Thoravi KUMARAVEL, Bellevue, WA (US); Sahithya RAVI, Vancouver (CA); Gabriel Herbert SARCH, Pittsburgh, PA (US)

(73) Assignee: Microsoft Technology Licensing, LLC, Redmond, WA (US)

(21) Appl. No.: 19/096,422

(22) Filed: Mar. 31, 2025

Related U.S. Application Data
(60) Provisional application No. 63/758,809, filed on Feb. 14, 2025.

(51) Int. Cl. G06F 9/451; G06F 3/01; G06T 7/10

(52) U.S. Cl. CPC G06F 9/453; G06F 3/013; G06T 7/10; G06T 2207/10016

(57) ABSTRACT

This document relates to using machine learning models to assist users with real world tasks. The disclosed implementations can obtain a demonstration video of a first user performing a real world task. Then, the demonstration video can be processed to obtain augmentation data that can be used at a later time to assist another user with performing the task. For instance, the augmentation data can include keyframes from the demonstration video or captions generated for the keyframes. When another user attempts to perform the task, selected augmentation data can be retrieved and used to prompt a generative model to answer user queries relating to the task.

### BACKGROUND

In recent years, generative machine learning models have demonstrated tremendous capability at generating content. For instance, generative language models can generate text to summarize existing documents, help users draft new documents, and conduct natural language conversations with users at a very high level. As another example, generative image models can generate realistic and/or aesthetically-pleasing images from natural language prompts, and they can also modify existing images by restyling them and/or adding objects.

However, generative machine learning models have various limitations for certain applications. For instance, human beings perform many real-world tasks that involve physical interaction with their environment, and generative machine learning models are not adept at understanding how humans interact with the physical world. Thus, generative machine learning models are not well-equipped to assist users with many real-world tasks.

### SUMMARY

This Summary is provided to introduce a selection of concepts in a simplified form. These concepts are further described below in the Detailed Description. This Summary is not intended to identify key features or essential features of the claimed subject matter, nor is it intended to be used to limit the scope of the claimed subject matter.

The description generally relates to techniques for assisting users with performing tasks using generative machine learning models. One example includes a computer-implemented method that can include obtaining a demonstration video of a demonstration of a particular task by a first entity. The method can also include obtaining one or more contextual signals associated with the demonstration video. The method can also include segmenting the demonstration video into multiple video segments based at least on the one or more contextual signals. The method can also include generating augmentation data associated with individual video segments of the demonstration video using a multi-modal generative model. The method can also include storing the augmentation data in a database. The augmentation data in the database can provide a basis for subsequent retrieval-automated generation of answers to queries relating to the particular task by a second entity.

Another example includes a computer-implemented method that can include receiving a query relating to performance of a particular task that has been demonstrated by a first entity, the query being received from a second entity. The method can also include receiving an input image depicting an attempt to perform the particular task by the second entity. The method can also include accessing a database having augmentation data for individual video segments relating to demonstration of the particular task by the first entity. The method can also include retrieving, from the database, selected augmentation data based at least on the input image. The method can also include inputting the selected augmentation data to a multi-modal generative model with a prompt requesting generation of an answer to the query based at least on the selected augmentation data. The method can also include receiving the generated answer from the multi-modal generative model. The method can also include outputting the answer to the second entity.

Another example entails a system that includes a processor and a storage medium storing instructions. When executed by the processor, the instructions can cause the system to receive a query relating to performance of a particular task that has been demonstrated by a first entity, the query being received from a second entity. The instructions can also cause the system to receive an input image relating to the query. The instructions can also cause the system to access a database having augmentation data for individual video segments relating to demonstration of the particular task by the first entity. The instructions can also cause the system to retrieve, from the database, selected augmentation data based at least on the input image. The instructions can also cause the system to input the selected augmentation data to a multi-modal generative model. The instructions can also cause the system to prompt the multi-modal generative model to generate an answer to the query based at least on the selected augmentation data. The instructions can also cause the system to receive the generated answer from the multi-modal generative model. The instructions can also cause the system to output the answer to the second entity.

The above-listed examples are intended to provide a quick reference to aid the reader and are not intended to define the scope of the concepts described herein.

### BRIEF DESCRIPTION OF THE DRAWINGS

The Detailed Description is described with reference to the accompanying figures. In the figures, the left-most digit(s) of a reference number identifies the figure in which the reference number first appears. The use of similar reference numbers in different instances in the description and the figures may indicate similar or identical items.

FIG. 1 shows an overall workflow for demonstration-based task assistance, consistent with some implementations of the present concepts.

FIG. 2 shows example video frames from a demonstration video of a particular task, consistent with some implementations of the present concepts.

FIGS. 3A and 3B show example temporal segments of video frames from a demonstration video of a particular task, consistent with some implementations of the present concepts.

FIGS. 4A and 4B show example keyframes for respective temporal segments of a demonstration video of a particular task, consistent with some implementations of the present concepts.

FIG. 5A shows an example input frame and a query requesting assistance with a particular task, consistent with some implementations of the present concepts.

FIG. 5B shows retrieved keyframes for assisting a user with a particular task, consistent with some implementations of the present concepts.

FIG. 5C shows an example answer provided to a user to assist them with a particular task, consistent with some implementations of the present concepts.

FIG. 6 illustrates an example of a system in which the disclosed implementations can be performed, consistent with some implementations of the present concepts.

FIG. 7A illustrates a first example method or technique, consistent with some implementations of the disclosed techniques.

FIG. 7B illustrates a second example method or technique, consistent with some implementations of the disclosed techniques.

FIG. 8 illustrates an example vision language model, consistent with some implementations of the present concepts.

FIGS. 9 and 10 illustrate example computer vision models, consistent with some implementations of the present concepts.

FIG. 11 illustrates a generative language model, consistent with some implementations of the present concepts.

FIG. 12 illustrates a generative image model, consistent with some implementations of the present concepts.

### DETAILED DESCRIPTION

### Overview

As noted above, generative machine learning models tend to lack the ability to assist users with real-world tasks that involve physical interaction with the environment. There are several reasons for these limitations. First, consider the training data typically used for a generative machine learning model. A generative language model might be trained using a token prediction task on a large corpus of natural language documents, while a generative image model might be trained to remove noise that has been added to an image. These training tasks and the associated training data do not adequately equip a generative machine learning model to assist users with real-world tasks that involve multiple steps and physical interaction with their environment.

The disclosed implementations can use a generative machine learning model to assist an entity with performing a real-world task, such as making coffee, repairing a car, etc. For instance, a first entity (a human, robot, etc.) can perform a demonstration of the task. As the first entity performs the demonstration of the task, a video of the first entity can be obtained with contextual signals, such as speech by the first entity, gaze direction by the first entity, gestures by the first entity, etc. Then, the video can be segmented based on the contextual signals, and augmentation data can be obtained for individual segments of the video. For instance, the augmentation data can include keyframes from individual segments and/or captions of the keyframes.

At a later time, a second entity can attempt to perform the task. When the second entity reaches a point where they are not certain what action to take, the second entity can query for assistance. Then, selected augmentation data can be retrieved from the database based on one or more images of the second entity attempting to perform that task. The selected augmentation data can include relevant keyframes from the demonstration video and/or captions of the keyframes, which can be used as context for a generative machine learning model to generate an answer to the query. The answer to the query provided by the generative machine learning model can then be output to the second entity.

In this manner, the generative machine learning model can assist the second entity with performing part of the task. Because the generative machine learning model receives relevant augmentation data as context with the query, the generative machine learning model can determine an answer to the query that effectively assists the second entity. This is true even if the generative machine learning model has not been trained or tuned on the particular task being performed.

### Machine Learning Overview

There are various types of machine learning frameworks that can be trained to perform a given task. Support vector machines, decision trees, and neural networks are just a few examples of machine learning frameworks that have been used in a wide variety of applications, such as image processing and natural language processing. Some machine learning frameworks, such as neural networks, use layers of nodes that perform specific operations.

In a neural network, nodes are connected to one another via one or more edges. A neural network can include an input layer, an output layer, and one or more intermediate layers. Individual nodes can process their respective inputs according to a predefined function, and provide an output to a subsequent layer, or, in some cases, a previous layer. The inputs to a given node can be multiplied by a corresponding weight value for an edge between the input and the node. In addition, nodes can have individual bias values that are also used to produce outputs. Various training procedures can be applied to learn the edge weights and/or bias values. The term “parameters” when used without a modifier is used herein to refer to learnable values such as edge weights and bias values that can be learned by training a machine learning model, such as a neural network.

A neural network structure can have different layers that perform different specific functions. For example, one or more layers of nodes can collectively perform a specific operation, such as pooling, encoding, or convolution operations. For the purposes of this document, the term “layer” refers to a group of nodes that share inputs and outputs, e.g., to or from external sources or other layers in the network. The term “operation” refers to a function that can be performed by one or more layers of nodes. The term “model structure” refers to an overall architecture of a layered model, including the number of layers, the connectivity of the layers, and the type of operations performed by individual layers. The term “neural network structure” refers to the model structure of a neural network. The term “trained model” and/or “tuned model” refers to a model structure together with parameters for the model structure that have been trained or tuned. Note that two trained models can share the same model structure and yet have different values for the parameters, e.g., if the two models are trained on different training data or if there are underlying stochastic processes in the training process.

There are many machine learning tasks for which there is a relative lack of training data. One broad approach to training a model with limited task-specific training data for a particular task involves “transfer learning.” In transfer learning, a model is first pretrained on another task for which significant training data is available, and then the model is tuned to the particular task using the task-specific training data.

The term “pretraining,” as used herein, refers to model training on a set of pretraining data to adjust model parameters in a manner that allows for subsequent tuning of those model parameters to adapt the model for one or more specific tasks. In some cases, the pretraining can involve a self-supervised learning process on unlabeled pretraining data, where a “self-supervised” learning process involves learning from the structure of pretraining examples, potentially in the absence of explicit (e.g., manually-provided) labels. Subsequent modification of model parameters obtained by pretraining is referred to herein as “tuning.” Tuning can be performed for one or more tasks using supervised learning from explicitly-labeled training data, in some cases using a different task for tuning than for pretraining.

### Terminology

The term “demonstration video,” as used herein, refers to a video depicting a task being performed by an entity, such as a human or robot. Note that a demonstration video does not necessarily depict the entity that performs the task. The term “contextual signal” refers to any information that conveys context associated with an entity when performing or attempting to perform a task. For example, contextual signals can include gaze signals indicating where the entity is looking, speech signals indicating words spoken by the entity, gesture signals indicating gestures performed by the entity, etc. The term “augmentation data” refers to any data derived from a demonstration of a task that can be used as a later time to augment a prompt to a generative model requesting an answer to a query related to the task.

The term “generative model,” as used herein, refers to a machine learning model employed to generate new content. One type of generative model is a “generative language model,” which is a model that can generate new sequences of text given some input. One type of input for a generative language model is a natural language prompt, e.g., a query potentially with some additional context. For instance, a generative language model can be implemented as a neural network, e.g., a long short-term memory-based model, a decoder-based generative language model, etc. Examples of decoder-based generative language models include versions of models such as GPT, BLOOM, PaLM, Mistral, Gemini, and/or LLAMA. Generative language models can be trained to predict tokens in sequences of textual training data. When employed in inference mode, the output of a generative language model can include new sequences of text that the model generates.

Another type of generative model is a “generative image model,” which is a model that generates images or video. For instance, a generative image model can be implemented as a neural network, e.g., a generative image model such as one or more versions of Stable Diffusion, DALL-E, Sora, or GENIE. A generative image model can generate new image or video content using inputs such as a natural language prompt and/or an input image or video. One type of generative image model is a diffusion model, which can add noise to training images and then be trained to remove the added noise to recover the original training images. In inference mode, a diffusion model can generate new images by starting with a noisy image and removing the noise.

In some cases, a generative model can be multi-modal. For instance, a model may be capable of using various combinations of text, images, video, audio, application states, code, or other modalities as inputs and/or generating combinations of text, images, video, audio, application states, or code or other modalities as outputs. Here, the term “generative language model” encompasses multi-modal generative models where at least one mode of output includes natural language tokens. Likewise, the term “generative image model” encompasses multi-modal generative models where at least one mode of output includes images or video. Examples of multi-modal models include certain GPT variants such as GPT-4o, variants of Gemini, etc. Multi-modal models can also include lightweight models such as Phi-3-Vision-128K-Instruct.

In addition, some generative models can include computer vision capabilities. These models are capable of recognizing objects in input images. The term “computer vision model” encompasses multi-modal models such as one or more versions of CLIP (Contrastive Language-Image Pre-Training) and BLIP (Bootstrapping Language-Image Pre-Training). Note the term “computer vision model” also encompasses non-generative models, such as ResNet, Faster-RCNN, etc. The term “input image” refers to one or more static images and/or frames from a video.

The term “prompt,” as used herein, refers to input provided to a generative model that the generative model uses to generate outputs. A prompt can be provided in various modalities, such as text, an image, audio, video, etc. The term “language generation prompt” refers to a prompt to a generative model where the requested output is in the form of natural language. The term “image generation prompt” refers to a prompt to a generative model where the requested output is in the form of an image.

The term “machine learning model” refers to any of a broad range of models that can learn to generate automated user input and/or application output by observing properties of past interactions between users and applications. For instance, a machine learning model could be a neural network, a support vector machine, a decision tree, a clustering algorithm, etc. In some cases, a machine learning model can be trained using labeled training data, a reward function, or other mechanisms, and in other cases, a machine learning model can learn by analyzing data without explicit labels or rewards.

### Example Workflow

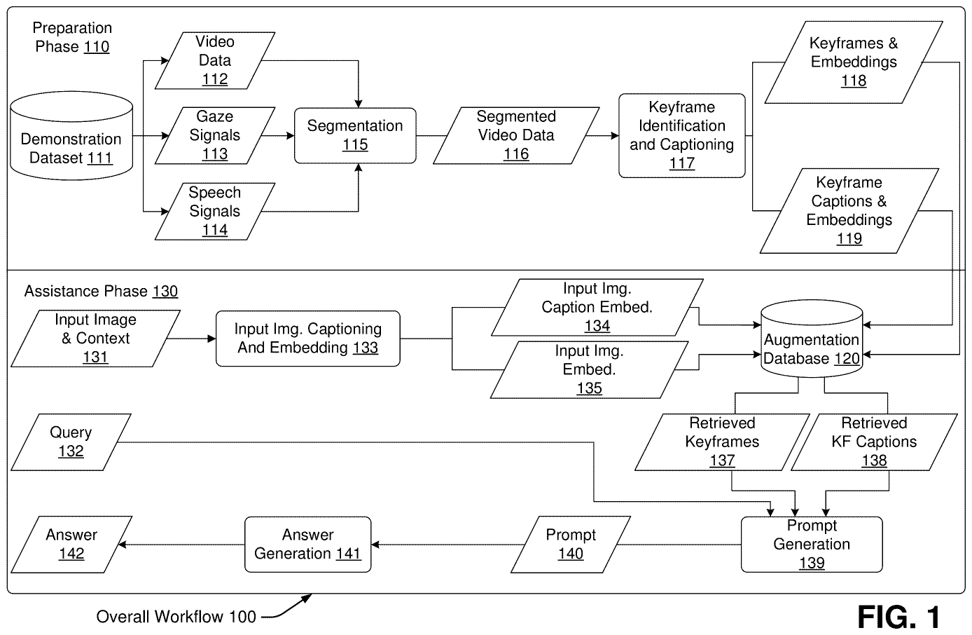

FIG. 1 shows an overall workflow 100. The overall workflow includes a preparation phase 110 and an assistance phase 130. Generally speaking, the preparation phase involves processing one more demonstration videos of one or more entities performing one or more tasks to obtain augmentation data. The assistance phase involves employing the augmentation data to assist one or more second entities in performing one or more of the demonstrated tasks. For instance, the augmentation data can be used as context for prompting a generative multi-modal model to answer queries by the second entities relating to a given task.

The preparation phase 110 starts by accessing a demonstration data set 111. Video data 112, gaze signals 113, and speech signals 114 are extracted from the demonstration data set. The video data includes videos from demonstrations of tasks by one or more first entities. The gaze data identifies where the first entities were looking when the demonstration videos were taken, and the speech data identifies words spoken by the first entities while the demonstration videos were taken.

The video data 112, gaze signals 113, and speech signals 114 are retrieved from the demonstration dataset and input to segmentation 115. During segmentation, the video data is divided into logical segments based on the gaze signals and/or the speech signals. The resulting segmented video data 116 is input to keyframe identification and captioning 117. Keyframe identification and captioning can involve identifying keyframes for each segment of the video data as well as captioning the keyframes, both of which can be performed by a multi-modal generative model. The keyframes and captions can be processed to generate embeddings representing the keyframes and captions in a vector space, e.g., using an image encoder and text encoder, respectively. The resulting keyframes and keyframe embeddings 118 and keyframe captions and keyframe caption embeddings 119 are used to populate an augmentation database 120. The preparation phase 110 can conclude once the augmentation database is populated.

The assistance phase 130 can involve receiving an input image and context 131 and a query 132. The input image can depict a second entity attempting to perform a particular task, and the input image can be a static image or one or more frames from a video. The input image can be received with context indicating gaze, speech, etc. by the second entity while the second entity is attempting to perform the task. The input image and context can be processed using input image captioning and embedding 133 to obtain an input image caption embedding 134 and an input image embedding 135. The input image caption embedding and the input image embedding are used to retrieve selected augmentation data from the augmentation database 120. For instance, the selected augmentation data can include retrieved keyframes 137 and retrieved keyframe captions 138. Prompt generation 139 uses the query 132, the retrieved keyframes, and the retrieved keyframe captions to generate a prompt 140. The prompt 140 is used during answer generation 141 to generate an answer 142 to the query. As described more below, the inclusion of the retrieved keyframes and keyframe captions in the prompt can assist a generative multi-modal model with generating an accurate answer to the query.

### Example Preparation Phase Processing

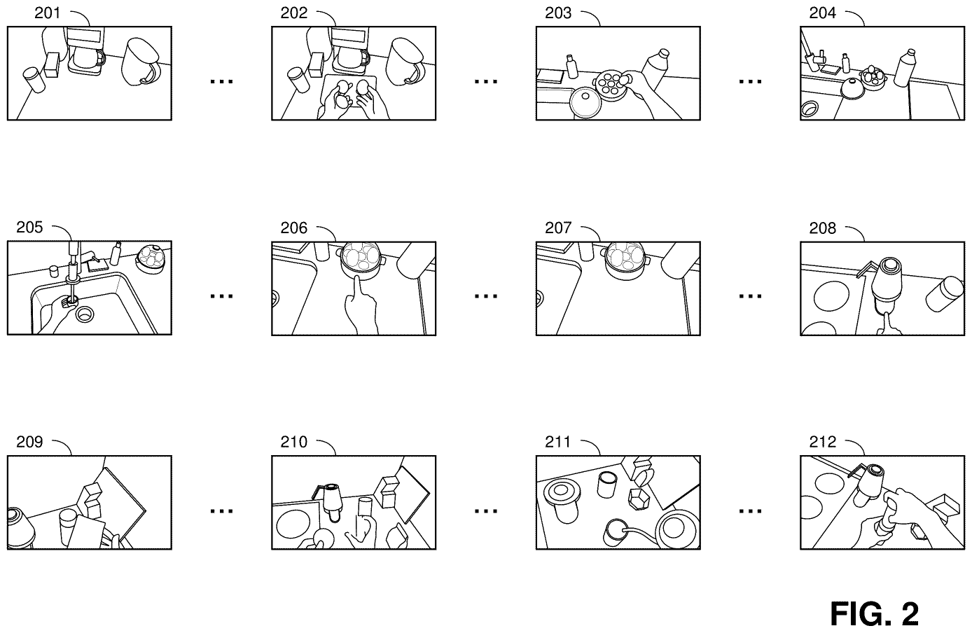

The following describes how preparation phase 110 of overall workflow 100 can be implemented using a set of example video frames from a demonstration. FIG. 2 shows 12 frames—frame 201, frame 202, frame 203, frame 204, frame 205, frame 206, frame 207, frame 208, frame 209, frame 210, frame 211, and frame 212. These frames show a video from the perspective of a first user, making eggs and coffee. Note that it is not practical to show every single frame, so FIG. 2 employs ellipses to convey that there can be one or more other frames between each frame shown in the figure.

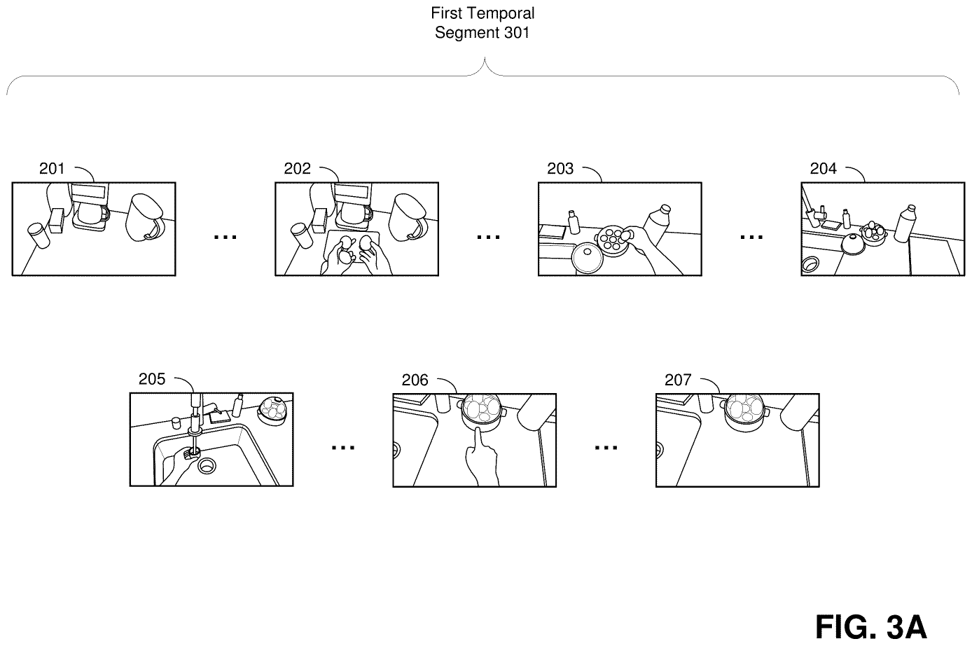

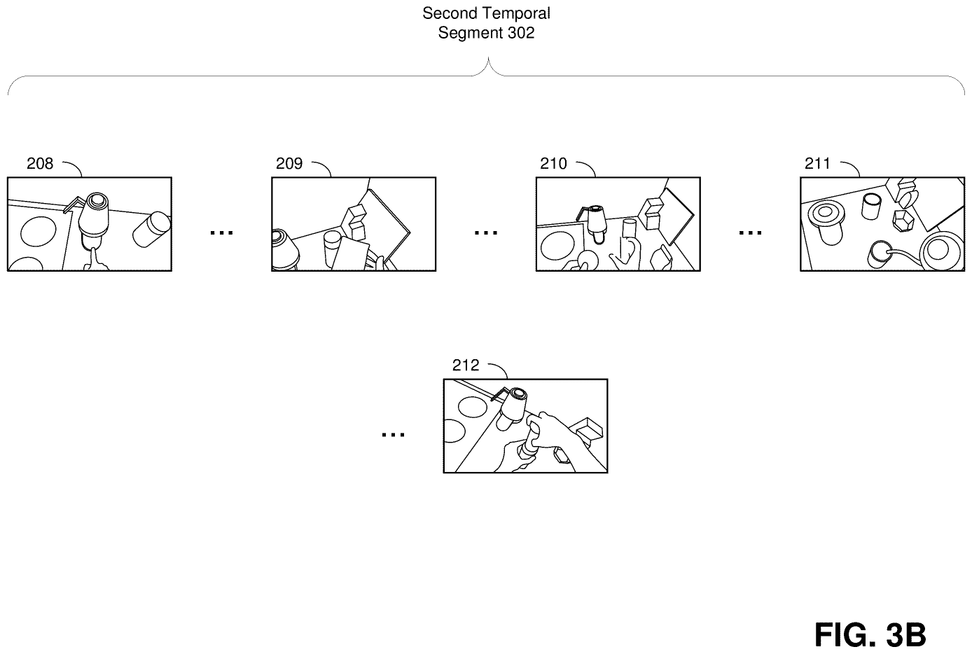

FIGS. 3A and 3B shows two example temporal segments extracted from the demonstration video. FIG. 3A shows temporal segment 301, which includes frames 201 through 207. FIG. 3B shows temporal segment 302, which includes frames 208 through 212. Recall from FIG. 1 that contextual signals such as gaze and/or speech can be employed to segment demonstration videos. Here, the video frames are shown from the perspective of the user demonstrating the task of making breakfast. During first temporal segment 301, the user's gaze is largely (although not entirely) directed to an egg maker and/or eggs that the user is preparing. During second temporal segment 302, the user's gaze is largely (although not entirely) directed to a coffee maker and associated objects that the user employs to make coffee. Thus, the user's gaze can be used to infer where the user's overall attention is directed during the first and second temporal segments. In other cases, the user's speech could be used in addition to or without gaze signals. For instance, the user might be discussing the egg maker during the first temporal segment and the coffee maker during the second temporal segment, and the change of topic can be used to infer when to segment the video.

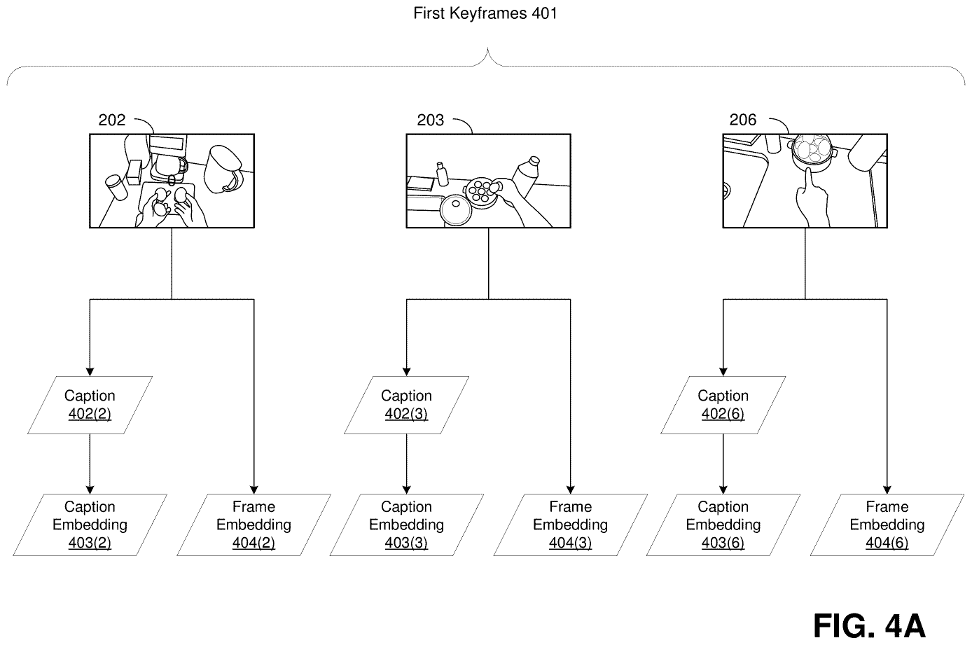

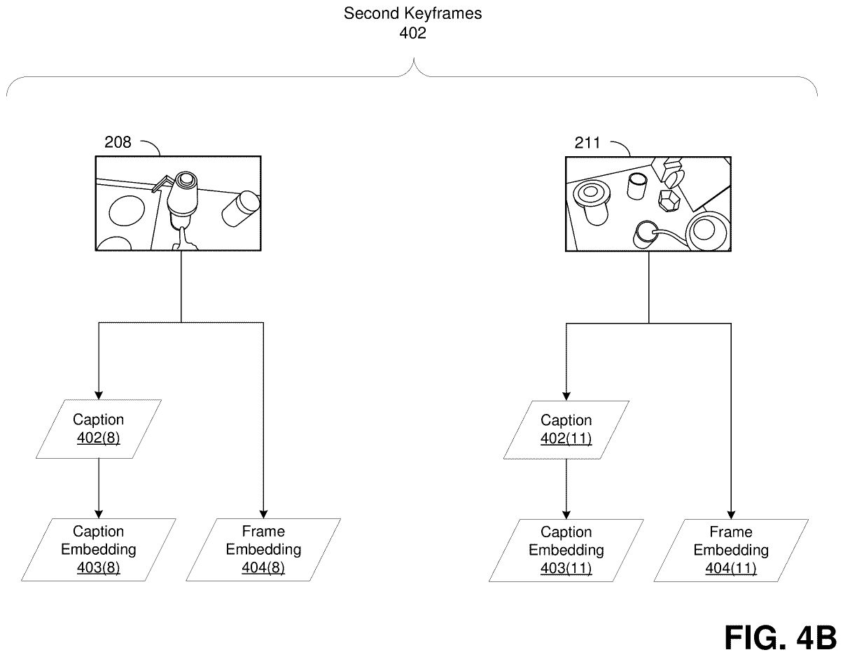

Once the demonstration video has been segmented, a generative multi-modal model can be employed to select keyframes for each segment. FIG. 4A shows frame 202, 203, and 206 selected as first keyframes 401 for the first temporal segment 301. Frame 202 is processed to obtain a caption 402(2), a caption embedding 403(2), and a frame embedding 404(2). Frame 203 is processed to obtain a caption 402(3), a caption embedding 403(3), and a frame embedding 404(3). Frame 206 is processed to obtain a caption 402(6), a caption embedding 403(6), and a frame embedding 404(6). FIG. 4B shows frame 208 and 211 selected as second keyframes 402 for the second temporal segment 302. Frame 208 is processed to obtain a caption 402(8), a caption embedding 403(8), and a frame embedding 404(8). Frame 211 is processed to obtain a caption 402(11), a caption embedding 403(11), and a frame embedding 404(11).

### Example Assistance Phase Processing

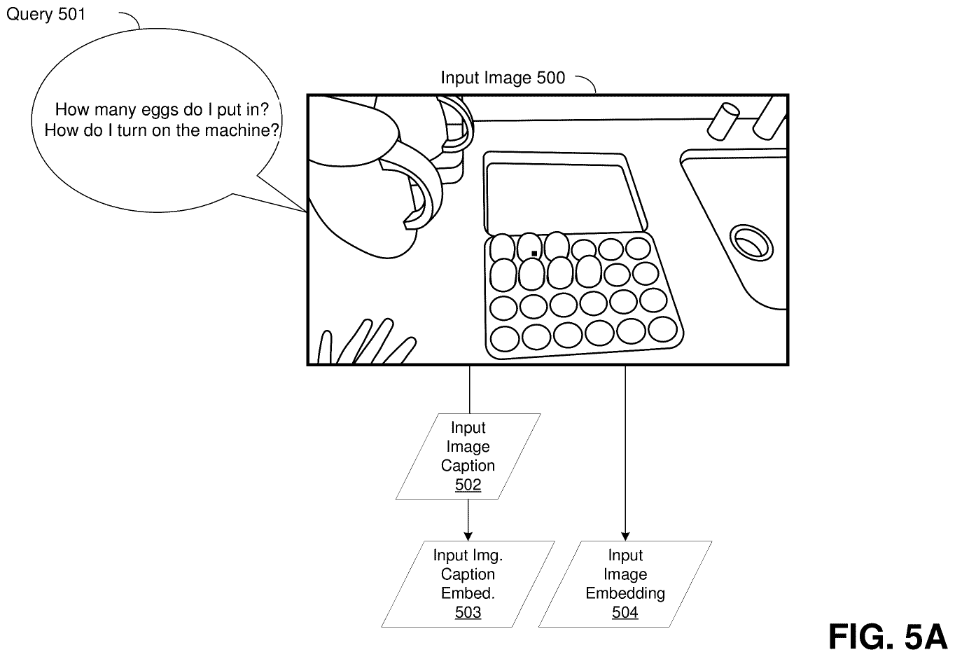

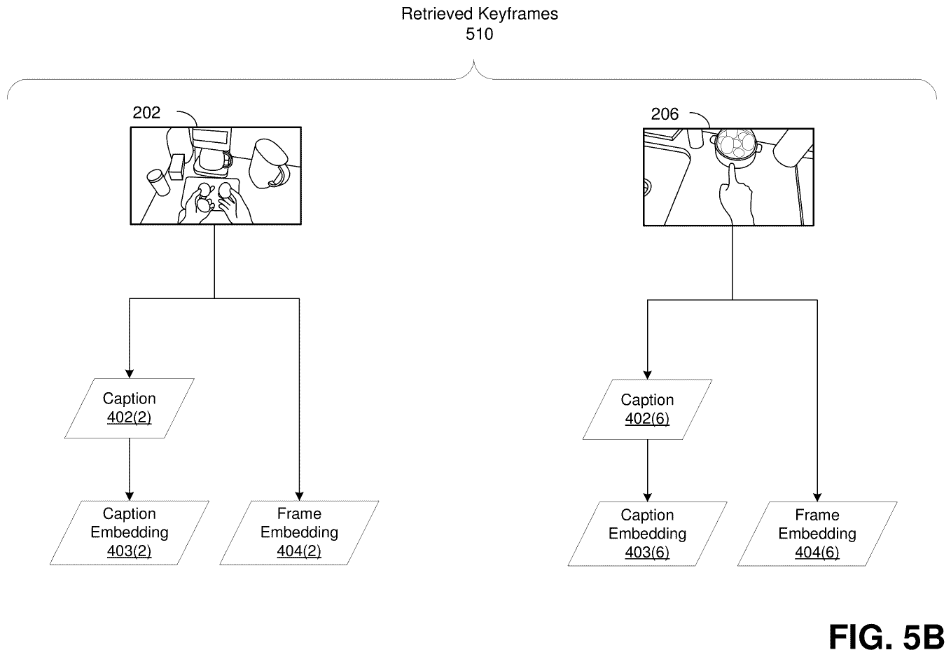

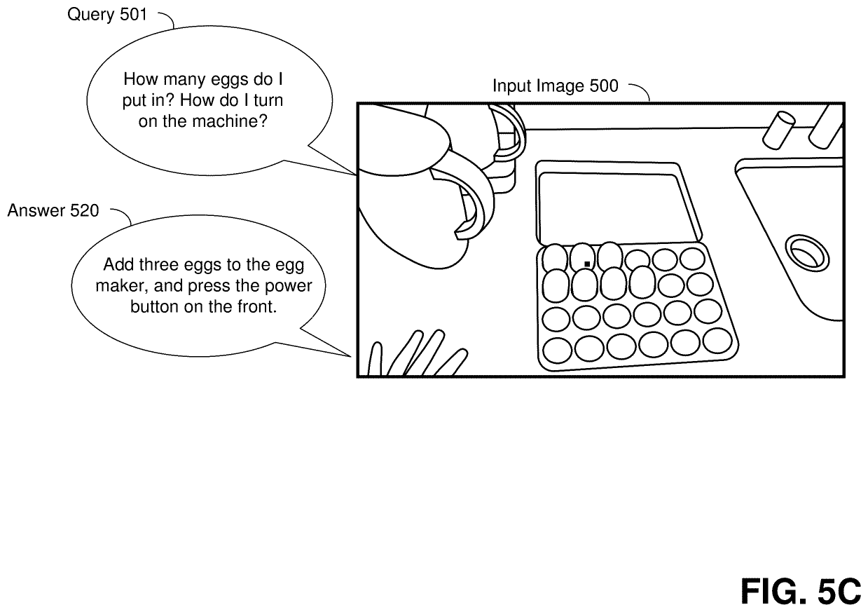

The following describes how assistance phase 130 of overall workflow 100 can be implemented based on the example demonstration described above. FIG. 5A shows an input image 500 with a corresponding query 501. Here, a second user is attempting to make eggs, and the input image shows the second user attempting to do so from the perspective of the second user. The query has two specific questions that the second user would like to have answered.

The input image 500 can be received with context, such as a gaze signal indicating that the second user is looking at the eggs shown in the input image. This information can be provided to a generative multi-modal model to obtain an input image caption 502, e.g., “The user is in a kitchen and looking at a carton of eggs.” A text encoder can be applied to the input image caption to obtain an input image caption embedding 503, and an image encoder can be applied to the input image to obtain an input image embedding 504.

The input image caption embedding 503 and the input image embedding 504 can be used to retrieve selected augmentation data from the augmentation database 120. Here, FIG. 5B shows retrieved keyframes 510, which include frame 202 which is retrieved with keyframe caption 402(2) and frame 206 which is retrieved with keyframe caption 402(6). Collectively, frame 202, keyframe caption 402(2), frame 206, and keyframe caption 402(6) can be employed as selected augmentation data for generating a prompt to a generative multi-modal model. By providing this information to the generative multi-modal model with the query 501, the generative multi-modal model can employ the retrieved keyframes and keyframe captions as relevant context from a previous demonstration to answer the query. FIG. 5C shows an answer 520 provided to the user based on the query, the retrieved keyframes, and the retrieved keyframe captions.

### Specific Implementation

The following describes one specific implementation of the present concepts. For the following description, consider a scenario where an assistant employs a generative machine learning model, such as a vision-language model, to assist a user with performing a real-world task. The following describes a specific approach to equip the generative language model to answer questions related to this activity in a contextualized manner. This scenario is particularly relevant for scenarios where users employ devices such as smart glasses, as the present concepts can allow such devices to quickly adapt their responses based on the user's preferences, habits, or current context to provide effective assistance.

Initially, a first user wearing smart glasses can perform a demonstration of a task. The smart glasses can obtain a sequence of video frames captured from the viewpoint of the first user. The video frames can be red, green, and blue pixel data and are denoted below as Iₜ at each time step t. The smart glasses can also capture explicit and implicit cues. Explicit cues can include natural language speech transcriptions, N=(n, s, e), where n represents the text segment spoken by the user, s denotes the start time, and e denotes the end time. These transcriptions capture the user's verbal descriptions of their actions. One example of implicit cues involves using eye gaze gₜ, with gaze origin pₜ∈ [symbol] and gaze direction dₜ∈ [symbol] . Another type of implicit cue involves hand pose tracking data Kₜ∈ [symbol] for each hand keypoint k. These explicit and implicit cues can be stored by the assistant for use at a later time, as described more below.

An evaluation episode involves another user performing the same task with help from the assistant. An evaluation episode is defined by a 3-tuple: (Q, D, A*). Here, Q represents an open-vocabulary question-image query with eye gaze and hand pose from the second user, D is the demonstration provided by the first, and A* is the ground truth answer. For instance, the ground truth answer can be annotated by a human, based on the demonstration D. The assistant's task is to generate a natural language answer A=assistant(Q, D) that closely matches the ground truth answer A*.

The present concepts can employ in-context learning to guide the assistant in effectively performing an objective. Here, that objective involves discerning the pertinent contextual examples from a provided demonstration for a given query-image pair (Q, I). By leveraging explicit cues, such as speech transcriptions, and implicit cues, like eye gaze data, the assistant can be provided with a contextual understanding of the tasks at hand. This context, in turn, enables the assistant to generate more accurate and personalized responses.

As noted above, the following are examples of types of context:
1. Gaze: Using eye gaze trajectories, gₜ, as implicit cues.
2. Speech: Using speech transcriptions, Iₜ, which are recordings of the user speaking aloud about their preferences and intentions, as explicit cues.
   The disclosed concepts can extract relevant context from user demonstrations, utilizing either implicit or explicit cues. This extracted context can then be added to the context window of a vision-language model, allowing the vision-language model to generate responses tailored to the user's intent and closely aligned with the desired output, A*.

A task demonstration can be processed using the following steps:
1. Segmenting the video temporally to identify key moments.
2. Extracting keyframes and generating captions for each identified segment.
   At each step, eye gaze and/or speech can be employed to provide context, as described below.

Generally speaking, it can be useful to understand user intent when performing a task. User intent refers to the underlying goal or purpose behind a user's actions, and accurately identifying user intent can be quite useful for providing personalized and contextually relevant assistance. Given a demonstration D, some implementations can first determine the user's overall intent for the entire activity (e.g., “The user is cleaning a room”) to contextualize future steps towards the overall goal.

For instance, one specific way to infer user intent from a demonstration is as follows. First, uniformly sample 50 frames from a video captured while a first user is demonstrating a task. These subsampled frames collectively represent the entire demonstration, and the vision-language model can then be prompted to infer and output a single, consistent intent that applies across all sampled frames. To provide additional contextual cues for inferring this intent, along with these frames, some implementations can also provide annotations from gaze data or speech data.

For the gaze data, some implementations can reproject the user's eye gaze from a 3D ray to a 2D image space using the camera's extrinsic and intrinsic parameters. Then, visual prompting can be employed to highlight the gaze point on the image and reference this point in the prompt. For the speech data, any speech uttered by the first user during the demonstration can be transcribed and appended to the prompt.

Some implementations can temporally segment the demonstration. This can be useful accurately capture and understand the sequence of events—discrete actions or occurrences within the activity—that occur in a long video demonstration. This can be even more useful for longer demonstrations. By breaking the video down into smaller segments, the disclosed techniques can better identify and track changes in user behavior and object interactions. This leads to a more comprehensive understanding of the overall demonstration.

One approach for temporal segmentation involves leveraging eye gaze data to perform object tracking and key moment boundary detection in videos. This can involve the following steps: 1) detecting fixations using in-clip consensus, 2) generating object proposals based on these fixations, and 3) tracking these objects to identify key moments of interaction changes.

Fixations can be detected by analyzing eye gaze points across multiple frames. For each frame t, object proposals

$$\{ {p}_{i}^{t} \}$$

can be generated using an image segmentation model given the gaze point as a prompt. An in-clip consensus is achieved by evaluating these proposals over a small temporal window of n frames, t, t+1, . . . , t+n−1. Fixations are identified as the object proposals that consistently appear in these frames, indicating sustained attention by the user.

Formally, following DEVA (Cheng, et al., “Tracking Anything with Decoupled Video Segmentation,” Proceedings of the IEEE/CVF International Conference on Computer Vision, 2023, pp. 1316-1326), let Segₜ₊ᵢ be the segmentation output at frame t+i, where 0≤i<n. Define the object proposals at frame t as the union of aligned segmentations across the temporal window:

$${P}_{t} = {{⋃}_{i = 0}}^{n - 1} {\hat{S}}_{t + i} = \{ {p}_{j} \vert 0 < j \leq \vert {P}_{t} \vert \}$$

The consensus output Cₜ is then determined by selecting those proposals pⱼ that have a high overlap with proposals in subsequent frames:

$${C}_{t} = \{ {p}_{j} ∈ {P}_{t} \vert IoU ( {p}_{j} , {p}_{k} ) > θ , ∀ k ∈ \{ t + 1 , ... , t + n - 1 \} \}$$

where IoU(pⱼ, pₖ) is the Intersection-over-Union between the j-th proposal at frame t and the k-th proposal in the subsequent frames, and θ is a threshold value.

Using the fixation-based object proposals, objects can be tracked across frames to monitor changes in user interaction. For instance, some implementations can propagate object masks from one frame to the next. Objects can be continuously tracked as long as they remain within the field of view. In some implementations, an object stops being tracked if it leaves the field of view for more than X frames or 7 seconds.

As the video progresses, new objects may enter the field of view or become relevant due to changes in user focus. New object proposals can be generated whenever a new fixation is detected outside the current consensus. These proposals can then be incorporated into the existing tracking framework using the same in-clip consensus method, allowing the model to dynamically adapt to the user's shifting focus.

One way to detect temporal boundaries is by monitoring significant changes in the consensus object proposals over time. A temporal boundary can be defined as the point in the video where there is a substantial change in the objects being tracked. Specifically, a boundary time b is marked when the set of tracked objects at time b differs from the set of tracked objects at the end of the previous segment by more than 50%. This change indicates that the user's focus has shifted to different objects, signaling a new segment in the video.

Another approach for implementing temporal segmentation involves the use of the speech uttered by the user during the demonstration to temporally segment the video. Some implementations employ the Whisper model (Radford, et al., “Robust Speech Recognition via Large-Scale Weak Supervision,” International conference on machine learning, July 2023, pp. 28492-28518, PMLR) to generate text segments, using the start and end times of the segments to define the temporal boundaries of segments in the video demonstration. An example speech segment is “Make sure it's mixed up nicely, no chunks.”

Once temporal segments are identified as described above, some implementations can use the vision-language model to analyze the segments based on the overall user intent as described above. This can involve identifying keyframes and generating descriptions of relevant information within each segment. For instance, some implementations first provide the vision-language model with 30 subsampled frames from the segment. The vision-language is then prompted to select the top-k most informative keyframes {K_{i,1}, K_{i,2}, . . . , K_{i,k}} and generate a detailed caption Cᵢ for the segment Tᵢ.

As noted, the overall task description can be provided to the vision-language model as context. For example, the overall task description could be that “The user is cleaning a room” or “The user is shopping for items for a bird house.”. Other implementations do not necessarily employ an overall task description as context, e.g., when explicit speech is provided by the user for a given temporal segment and provided to the model.

For each segment, the keyframes identified by the vision-language model and the keyframe captions generated by the vision-language model are stored in an augmentation database for in-context learning. The database stores each segment Tᵢ as follows:

$$DB ( {T}_{i} ) = \{ ( {K}_{i , 1} , {C}_{ij} ) , ( {K}_{i , 2} , {C}_{ij} ) , ... , ( {K}_{i , k} , {C}_{ij} ) \}$$

Here, DB(Tᵢ) denotes the database entries for segment Tᵢ, each consisting of a keyframe K_{i,j} and the corresponding caption Cᵢⱼ. The keyframes for each segment can be encoded into a visual vector (Radford, et al., “Learning Transferable Visual Models from Natural Language Supervision,” International Conference on Machine Learning, July 2021, pp. 8748-8763, PmLR), and the captions for each segment can be encoded into a semantic vector using a text encoder, such as OpenAI embedding models or BERT (Devlin, et al., “Bert: Pre-training of deep bidirectional transformers for language understanding,” Proceedings of the 2019 conference of the North American chapter of the association for computational linguistics: human language technologies, Volume 1 (long and short papers), June 2019, pp. 4171-4186). Given a new query, this structured storage facilitates efficient retrieval and use of keyframes and captions for retrieval-augmented generation, as described more below.

When a second user attempts to perform an activity that has been previously demonstrated, the database can be employed for inference as follows. For instance, the second user can provide a text query and corresponding visual input, such as an image and gaze data captured by smart glasses worn by the second user. The vision-language model can be employed to generate a caption for the image using a captioning model. For offline captioning, some implementations use GPT-4o, while Florence (Xiao, et al., “Florence-2: Advancing a unified representation for a variety of vision tasks,”. Proceedings of the IEEE/CVF Conference on Computer Vision and Pattern Recognition, 2024, pp. 4818-4829) can be employed for real-time inference.

The caption can be encoded using the text encoder, and the image can be processed through the visual encoder to obtain its visual embedding. Then, the cosine similarity between the text embedding and image embedding with each segment's embeddings in the database can be computed. The top-k highest-scoring entries can be retrieved from the database to use as context for retrieval-augmented generation.

The similarity score s for each entry can be calculated as follows:

$$s = {λ}_{textual} \cdot {s}_{textual} + {λ}_{visual} \cdot {s}_{visual}$$

where:
sₜₑₓₜᵤₐₗ is the similarity score based on the text embedding,
sᵥᵢₛᵤₐₗ is the similarity score based on the visual embedding, and
λₜₑₓₜᵤₐₗ, and λᵥᵢₛᵤₐₗ are weighting factors that determine the contribution of each type of embedding to the overall similarity score.
   The retrieved segment images and captions can be provided as context to the vision-language model when prompting the model to answer questions for the second user.

### Example System

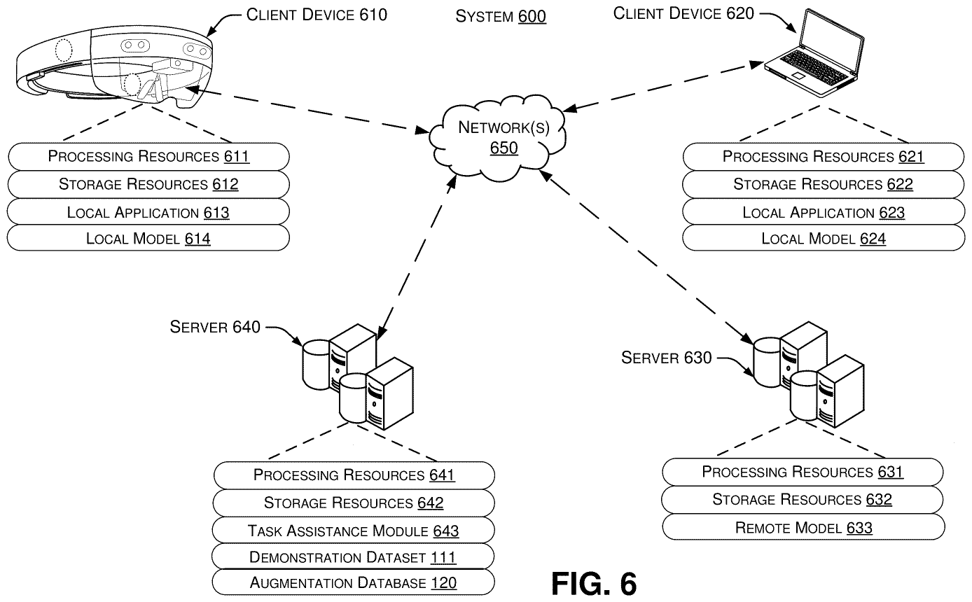

The present implementations can be performed in various scenarios on various devices. FIG. 6 shows an example system 600 in which the present implementations can be employed, as discussed more below.

As shown in FIG. 6, system 600 includes a client device 610, a client device 620, a server 630, and a server 640, connected by one or more network(s) 650. Note that the client device can be embodied both as a mobile device such as smart phones or tablets, as well as stationary devices such as desktops, server devices, etc. Likewise, the servers can be implemented using various types of computing devices. In some cases, any of the devices shown in FIG. 6, but particularly the servers, can be implemented in data centers, server farms, etc.

Client device 610 can have processing resources 611 and storage resources 612, client device 620 can have processing resources 621 and storage resources 622, server 630 can have processing resources 631 and storage resources 632, and server 640 can have processing resources 641 and storage resources 642. Each of these devices may also have various modules that function using the processing and storage resources to perform the techniques discussed herein. The storage resources can include both persistent storage resources, such as magnetic or solid-state drives, and volatile storage, such as one or more random-access memory devices. In some cases, the modules are provided as executable instructions that are stored on persistent storage devices, loaded into the random-access memory devices, and read from the random-access memory by the processing resources for execution.

Client device 610 can include one or more local application(s) 613 and one or more local models 614. Client device 620 can include one or more local applications 623 and one or more local models 624. Server 630 can host one or more remote models 633. Server 640 can host a task assistance module 643 that can perform overall workflow 100 using demonstration dataset 111 and augmentation database 120.

For instance, the local applications can provide a user interface for users to interact with the task assistance module 643 on server 640. First users of the client devices can demonstrate a task as described herein, and sensors such as a camera, eye tracker, microphone, inertial measurement units, etc. can obtain various contextual signals while the users demonstrate the task. The client devices can provide demonstration videos and contextual signals to the task assistance module, which can store the demonstration videos and contextual signals in demonstration dataset 111. The task assistance module can employ the local or remote models to obtain augmentation data to populate augmentation database 120. Later, second users of the client devices (or other client devices) can attempt to perform the task. The task assistance module can interact with the local applications to guide the second users to perform the task by retrieving relevant augmentation data from the augmentation database, such as keyframes, keyframe captions, etc. Then, the retrieved augmentation data can be used as context for prompting and using any of the local or remote models to generate an answer to a query by the second user.

Note that in other implementations, the task assistance module can be located on a client device. For instance, client device 610 can have a task assistance module provided as part of the local application 613. The client device can have a local augmentation database, e.g., received from server 640. Server 640 can receive demonstration videos from other client devices, process them to populate an augmentation database, and then provide copies of the augmentation database to the client devices. Alternatively, respective client devices can have their own task assistance modules that retrieve selected augmentation data from aa remote augmentation database on server 140.

### First Example Method

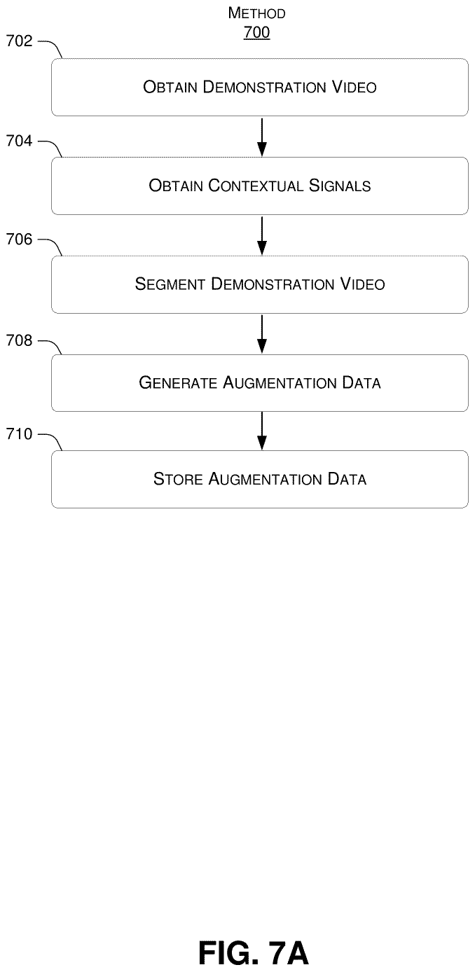

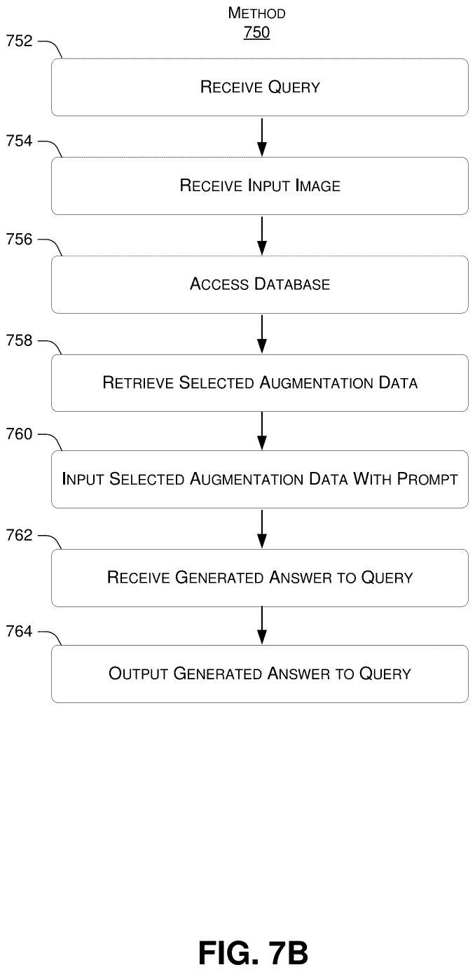

FIG. 7A illustrates an example computer-implemented method 700, consistent with some implementations of the present concepts. Method 700 can be implemented on many different types of devices, e.g., by one or more cloud servers, by a client device such as a laptop, tablet, or smartphone, or by combinations of one or more servers, client devices, etc. Method 700 can generally correspond to preparation phase 110 of overall workflow 100.

Method 700 begins at block 702, where a demonstration video is obtained of a task being performed by a first entity. For instance, a person or machine can perform the demonstration while one or more cameras record the demonstration. The demonstration video can show the demonstration from the perspective of the first entity (e.g., their field of view) or can depict a third-person view of the first entity.

Method 700 continues at block 704, where one or more contextual signals associated with the demonstration video are obtained. For instance, the contextual signals can include speech obtained using a microphone, gesture signals, gaze signals, etc. For instance, gesture signals could be obtained via a camera that captures an image of a user performing a gesture. Gestures can be predetermined gestures that correspond to a particular command or message, such as a thumbs-up for yes, thumbs-down for no, etc. Gestures can also be informative, e.g., the user may point at, touch, or grasp a particular object, point in a particular direction etc. Gaze signals can be obtained by tracking orientation of a user's head (e.g., using an inertial measurement unit), using eye tracking sensors, etc. Note that an inertial measurement unit could also be employed to capture user gestures, e.g., by detecting shaking of a user's head, movement of a hand, etc.

Method 700 continues at block 706, where the demonstration video is segmented into video segments based on the contextual signals. For instance, eye gaze and/or speech can be used to infer that the first entity changes focus to different objects depicted in the demonstration video over time. The change of focus can be used to infer that the intent of the first entity has changed, and a new temporal segment can begin when the intent of the first entity changes (e.g., from making eggs to making coffee).

Method 700 continues at block 708, where augmentation data is generated for individual video segments. For instance, the augmentation data can include keyframes selected for individual video segments and/or keyframe captions, as described above. More generally the augmentation data can include any other data that indicates the intent of the first entity during a given video segment.

Method 700 continues at block 710, where the augmentation data is stored in a database. The augmentation data in the database can provide a basis for subsequent retrieval-automated generation of answers to queries relating to the particular task by a second entity.

In some cases, some or all of method 700 is performed by a single device, e.g., on one client device or on one server. In other cases, some or all of method 700 is distributed across multiple devices.

### Second Example Method

FIG. 7B illustrates an example computer-implemented method 750, consistent with some implementations of the present concepts. Method 750 can be implemented on many different types of devices, e.g., by one or more cloud servers, by a client device such as a laptop, tablet, or smartphone, or by combinations of one or more servers, client devices, etc. Method 750 can generally correspond to assistance phase 130 of overall workflow 100.

Method 750 begins at block 752, where a query is received from a second entity that is attempting to perform a particular task. For instance, the query can include one or more questions that the second entity has about the task, e.g., when the second entity is not sure how to proceed.

Method 750 continues at block 754, where an input image is received. For instance, the input image can be a static image or one or more frames of a video depicting the second entity attempting to perform the task. The input image can be from a first-person perspective of the second entity or a third-person perspective and can depict a current state of the environment when the second entity provides the query.

Method 750 continues at block 756, where a database is accessed. The database can be populated with augmentation data for individual video segments relating to demonstration of the particular task by a first entity. For instance, the augmentation data can include keyframes for each segment, keyframe captions for the keyframes, or any other data that indicates the intent of the first entity during a given video segment.

Method 750 continues at block 758, where selected augmentation data is retrieved from the database. For instance, the input image can be processed to obtain an input image embedding, an input image caption, and an input image caption embedding. The input image embedding can be compared to the keyframe embeddings in the database and the input image caption embedding can be compared to the keyframe caption embeddings in the database to retrieve relevant keyframes and keyframe captions from the database. In some cases, the query is also used as a basis for retrieving selected augmentation data.

Method 750 continues at block 760, where the selected augmentation data is input to a multimodal generative machine learning model with a prompt requesting an answer to the query. For instance, the generative machine learning model can be a vision-enabled model, and the retrieved keyframes and/or retrieved captions can be input as context for the query.

Method 750 continues at block 762, where a generated answer is received from the generative machine learning model. For instance, the generated answer can be in the form of text, audio, and/or a generated or modified image that guides the second entity to perform the task.

Method 750 continues at block 764, where the answer is output to the second entity. The answer can be output by displaying text, playing back audio, displaying one or more images or video, etc.

In some cases, some or all of method 750 is performed by a single device, e.g., on one client device or on one server. In other cases, some or all of method 750 is distributed across multiple devices.

### Additional Implementations

The description above provided some specific examples of how the disclosed concepts can be employed. However, there are many alternative scenarios that can utilize the present concepts. For instance, in the examples above, a two-dimensional demonstration video showing a first entity performing a task was used to assist a second entity in performing that task, using a two-dimensional image or video depicting the second entity attempting to perform the task.

In further implementations, three-dimensional images or video of the first and/or second entity can be employed. For instance, consider a task that involves the first entity navigating a difficult course (e.g., a maze) that involves moving through a three-dimensional space. In this case, the demonstration video could be a three-dimensional representation of the first entity. The second entity could receive three-dimensional guidance, e.g., “How do I get back to the stairway” that shows the second entity directions to where they would like to go.

In some cases, the environment of the first and/or second entity can be partially-virtual or augmented reality environment or alternatively can be a fully-virtual environment. For instance, a two-dimensional video game is one type of virtual environment, where a demonstration of how to play the game by one entity can be used to assist another entity, e.g., with defeating a particular enemy or a particular level of the video game. This is also true for augmented or virtual reality three-dimensional video games, e.g., a video game player could request help finding a particular gem in a three-dimensional video game and that player could receive assistance based on augmentation data from a video of a different video game player finding the requested gem.

In other cases, online videos can be employed as a repository of demonstrations. For instance, assume a video service has several different videos of users performing a specific auto repair on a particular car, e.g., replacing the thermostat. Each of these videos can be segmented together based on speech by the users demonstrating the repair. Then, a user query such as “How do I install the thermostat gasket” could be used to retrieve selected keyframes or captions from demonstration videos that actually show the gasket being installed. Thus, instead of a user watching numerous videos until they finally find a video that shows how to replace the thermostat gasket, the disclosed concepts can be employed to selectively retrieve keyframes showing how the gasket can be replaced without requiring the user to watch every one of the videos demonstrating the overall task.

In some cases, the retrieved keyframes can be displayed to the user being assisted, e.g., together with a textual or spoken answer to the query. In further cases, an object of interest in one or more of the keyframes can be modified, e.g., by zooming in on the object or generating an unobstructed view of the object using a generative image model. In this case, the generated answer can include the modified keyframe itself.

### Technical Effect

As noted above, generative machine learning models have some drawbacks with respect to assisting users with real-world tasks, such as those involving physical interaction with the real world. While a generative model could theoretically be trained or tuned on a training data set of real-world tasks, this is computationally intensive and it is not clear how well a generative model would learn from tasks being performed by different users, in different physical environments, using different tools or appliances, etc.

Another theoretical approach could involve inputting an entire demonstration video to a generative machine learning model to extract augmentation data. However, many complex real-world tasks involve subtasks that are somewhat independent and may not be useful as context for other parts of the task. For instance, making breakfast with an egg maker and a coffee maker is a useful real-world task, but a generative machine learning model does not necessarily benefit from observing video of an entity making coffee when tasked with helping another entity make eggs. In fact, giving the generative machine learning model irrelevant context could result in hallucinations or otherwise inaccurate responses by the generative machine learning model. Further, many generative machine learning models have context window limitations that make this impractical, e.g., an entire demonstration video may be far too large to fit into the context window of a given model.

The disclosed concepts can segment a demonstration video into segments based on the inferred intent of the entity demonstrating a given task. Then, augmentation data can be extracted from the demonstration on a segment-by-segment basis. For instance, extracting keyframes and keyframe captions for each segment allows the information from each segment to be distilled into a much smaller representation. This involves far fewer calls to a generative model than processing the entire demonstration video as a whole and also reduces storage requirements dramatically.

The disclosed concepts also provide for reduced computational resources during the assistance phase. By retrieving a subset of the augmentation data that pertains specifically to the current context of the entity requesting assistance, the retrieved augmentation data can fit within the context window of the generative machine learning model that generates the answer. Furthermore, the retrieved augmentation data omits irrelevant augmentation data that could otherwise have resulted in hallucinations or otherwise inaccurate answers to queries by the entity receiving assistance.

### Example Vision Language Model

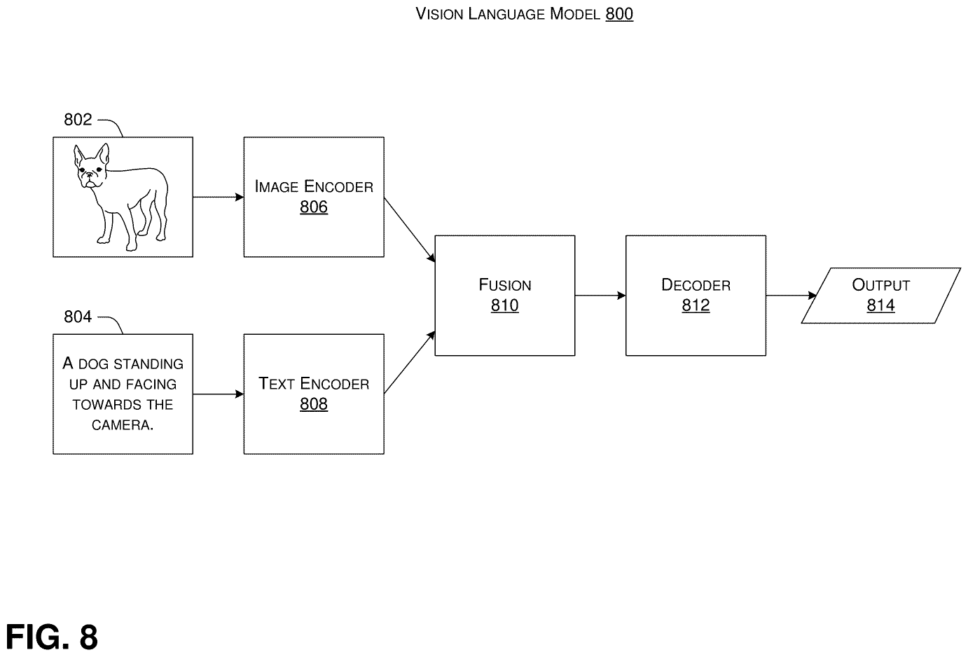

FIG. 8 shows an example vision language model 800 that can process an input image 802 and/or a text input 804. The input image is processed using an image encoder 806 (e.g., based on a computer vision model as described below) and the text input is processed using a text encoder 808. The image encoder and text encoder produce encodings (e.g., vector embeddings) representing the input image and text input, respectively. A fusion process 810 can fuse the encodings using techniques such as attention, dot product, etc. A decoder 812 can decode the fused encodings to produce an output 814.

In some implementations, the image encoder can also be based on a transformer architecture such as a Vision Transformer (Dosovitskiy, et al., “An Image is Worth 16×16 Words: Transformers for Image Recognition at Scale,” Jun. 3, 2021, arXiv preprint arXiv: 2010.11929v2). The text encoder 808 can be based on a transformer architecture such as BERT or GPT. In other cases, an “early fusion” approach can employ a shared encoder that processes sequences of text and image tokens using a single encoder that determines embeddings for each text or image token. (Chameleon. Team C, “Chameleon: Mixed-Modal Early-Fusion Foundation Models,” 2024, arXiv preprint, arXiv: 2405.09818).

The vision language model 800 can be trained using approaches such as contrastive learning, where the training data includes pairs of text and images and the model is trained to determine whether a given text sample matches a corresponding image sample. In this manner, the image encoder 806 and the text encoder 808 can be trained to generate similar embeddings for text and images that represent similar concepts (e.g., the word “bear” and an image of a bear). Other approaches include masked image modeling and/or masked language modeling and image-text modeling.

The output 814 can characterize an image. For instance, the output can answer a visual question, caption the image, etc. The output can also identify detected objects, classify detected objects, perform image segmentation, etc. In some cases, the vision language model 800 can determine a label for an object in an input image. The labels can identify a category of the object (e.g., “bed” or “sofa”), a description of the object (e.g., “a queen-sized bed with blue bedding and a headboard”), or even specify information such as a brand of the object (e.g., “ABC brand queen size platform bed”), etc. The output can also specify relationships between detected objects, e.g., “the bear is riding the unicycle in the circus ring,” etc.

### First Computer Vision Model

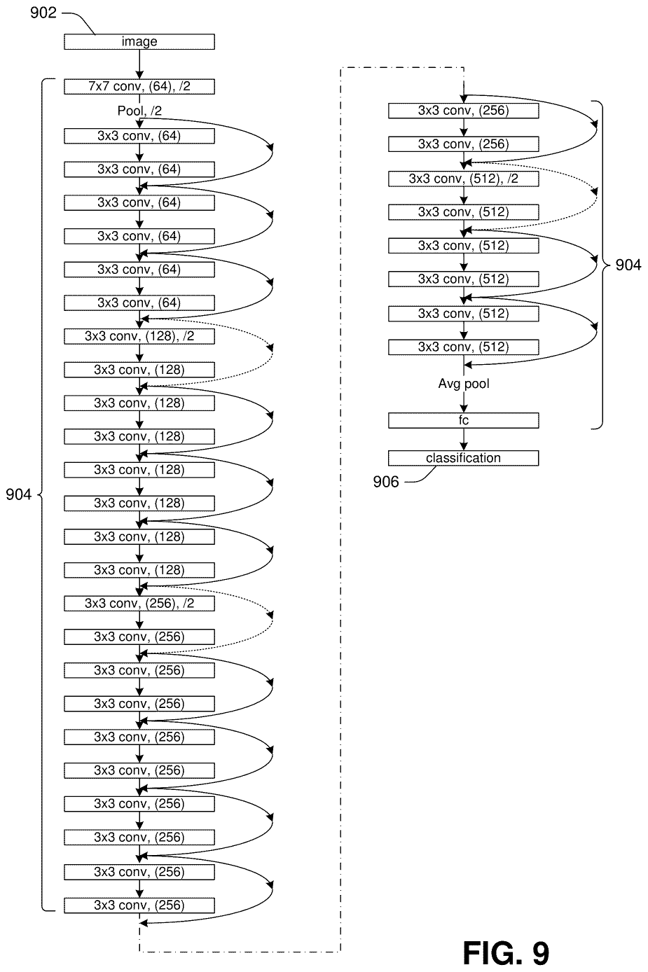

FIG. 9 illustrates a particular example of a neural network model for computer vision. For instance, FIG. 9 shows an image 902 being classified by a computer vision model 904 to determine an image classification 906, where the computer vision model can be a ResNet model (He, et al., “Deep Residual Learning for Image Recognition,” in Proceedings of the IEEE Conference on Computer Vision and Pattern Recognition, 2016, pp. 770-778). The computer vision model can include a number of convolutional layers, most of which have 3×3 filters. Generally, given the same output feature map size, the convolutional layers have the same number of filters (e.g., 64, 128, 256, 512). If the feature map size is halved by a given convolutional layer (as shown by “/2” in FIG. 9), then the number of filters can be doubled to preserve the time complexity across layers.

After the image has been processed using a series of convolutional layers, the image is processed in a global average pooling layer. The output of the pooling layer is processed with a fully-connected layer with softmax. The fully-connected layer (e.g., one thousand-way) can be used to determine a classification, e.g., an object category of an object in image 902.

The respective layers within computer vision model 904 can have shortcut connections which perform identity operations:

$$y = F ( x , \{ {W}_{i} \} ) + x \qquad ( 1 )$$

where x and y are the input and output vectors of the layers involved and F(x, {Wᵢ}) represents the residual mapping learned by the model. In some connections the dimensions increase across layers (shown as dotted lines in FIG. 9). In these cases, the following projection can be employed to match the dimensions via 1×1 convolutions:

$$y = F ( x , \{ {W}_{i} \} ) + {W}_{s} x \qquad ( 2 )$$

In some implementations, computer vision model 904 can be pretrained on a large dataset of images, such as ImageNet. Such a general-purpose image database can provide a vast number of training examples that allow the model to learn weights that allow generalization across a range of object categories. Said another way, computer vision model 904 can be pretrained in this fashion.

After pretraining, computer vision model 904 can be tuned on another, smaller dataset for categories of interest. For instance, tuning datasets can be provided for specific groups of users. As one example, software developers might tend to use UML (Unified Modeling Language) diagrams or directed acyclic graphs, whereas other users might tend to use conventional flow charts, and thus different computer vision models can be tuned for these different sets of users. As another example, social media users might tend to post images of things in their home, such as pets or furniture, whereas business users might tend to post images of graphs, scatterplots, pie charts, etc.

### Second Computer Vision Model

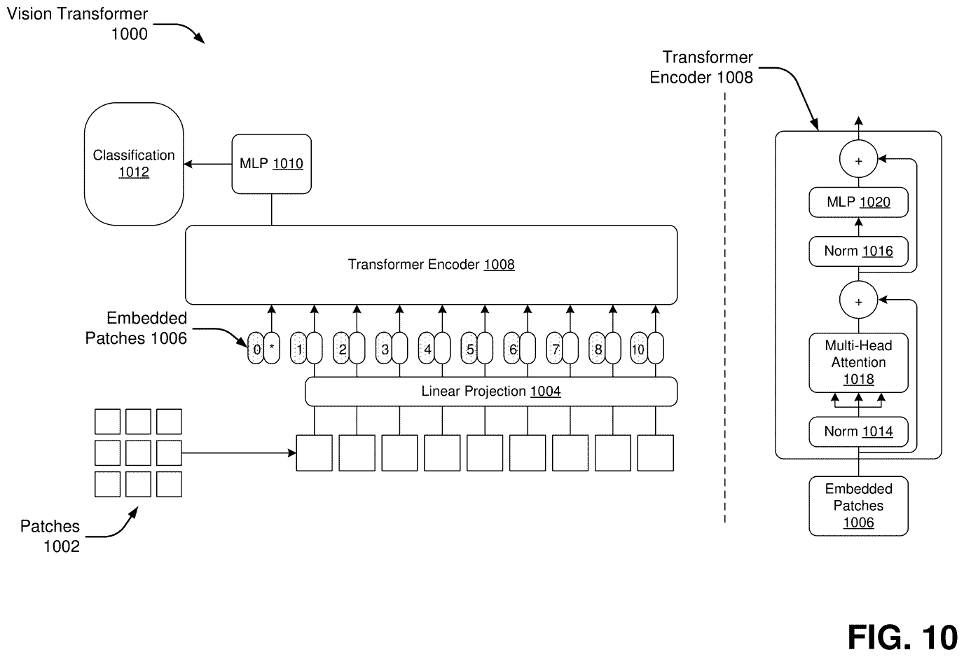

FIG. 10 shows a vision transformer 1000 that can be employed as a backbone (Dosovitskiy, et al., “An image is worth 16×16 words: Transformers for image recognition at scale,” 2020, arXiv preprint arXiv: 2010.1110210). The vision transformer receives patches from an image 1002, performs a linear projection 1004 on the patches, and inputs resulting embedded patches 1006 into a transformer encoder 1008. The output of the transformer encoder is processed using a multi-layer perceptron 1010, resulting in a classification 1012.

For example, some implementations can reshape an image into a sequence of flattened pixel patches at one or more resolutions. An embedding can be added to the sequence of embedded patches, and the transformer encoder 1008 can modify that embedding for processing by the multi-layer perceptron 1010.

The transformer encoder 1008 utilizes norm 1014 and norm 1016 to implement layer normalization processing that normalizes features. Multi-head attention layer 1018 can determine dependencies between individual image patches by computing attention scores between respective patches. MLP layer 1020 can process normalized outputs of the multi-head attention layer that can introduce non-linearity into the model and learn relationships between features received from the multi-head attention layer. Multiple transformer blocks can be provided, with each having respective multi-head self-attention, layer normalization, and/or multi-layer perceptron layers.

The vision transformer 1000 can be trained using a supervised learning approach, where a classification head is employed to predict class labels of images. The vision transformer parameters can be updated using a loss function such as cross-entropy loss. Once trained, the vision transformer can process input images to extract visual features that are useful for various downstream tasks, such as object segmentation as described above. Note that other backbone models can also be employed, such as convolutional backbone models like ResNet, MobileNet, etc.

### Example Decoder-Based Generative Language Model

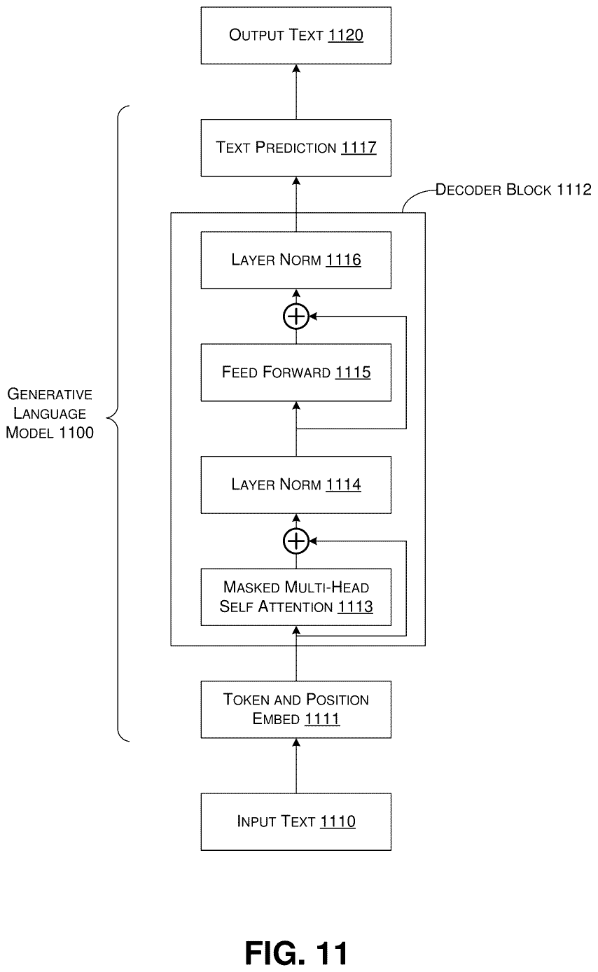

FIG. 11 illustrates an exemplary generative language model 1100 (e.g., a transformer-based decoder) that can be employed using the disclosed implementations. (Radford, et al., “Improving language understanding by generative pre-training,” 2018). Generative language model 1100 is an example of a machine learning model that can be used to perform one or more natural language processing tasks that involve generating text, as discussed more below. For the purposes of this document, the term “natural language” means language that is normally used by human beings for writing or conversation.

Generative language model 1100 can receive input text 1110, e.g., a prompt from a user or a prompt generated automatically by machine learning using the disclosed techniques. For instance, the input text can include words, sentences, phrases, or other representations of language. The input text can be broken into tokens and mapped to token and position embeddings 1111 representing the input text. Token embeddings can be represented in a vector space where semantically-similar and/or syntactically-similar embeddings are relatively close to one another, and less semantically-similar or less syntactically-similar tokens are relatively further apart. Position embeddings represent the location of each token in order relative to the other tokens from the input text.

The token and position embeddings 1111 are processed in one or more decoder blocks 1112. Each decoder block implements masked multi-head self-attention 1113, which is a mechanism relating different positions of tokens within the input text to compute the similarities between those tokens. Each token embedding is represented as a weighted sum of other tokens in the input text. Attention is only applied for already-decoded values, and future values are masked. Layer normalization 1114 normalizes features to mean values of 0 and variance to 1, resulting in smooth gradients. Feed forward layer 1115 transforms these features into a representation suitable for the next iteration of decoding, after which another layer normalization 1116 is applied. Multiple instances of decoder blocks can operate sequentially on input text, with each subsequent decoder block operating on the output of a preceding decoder block. After the final decoding block, text prediction layer 1117 can predict the next word in the sequence, which is output as output text 1120 in response to the input text 1110 and also fed back into the language model. The output text can be a newly-generated response to the prompt provided as input text to the generative language model.

Generative language model 1100 can be trained using techniques such as next-token prediction or masked language modeling on a large, diverse corpus of documents. For instance, the text prediction layer 1117 can predict the next token in a given document, and parameters of the decoder block 1112 and/or text prediction layer can be adjusted when the predicted token is incorrect. In some cases, a generative language model can be pretrained on a large corpus of documents. Then, a pretrained generative language model can be tuned using a reinforcement learning technique such as reinforcement learning from human feedback (“RLHF”).

### Example Generative Image Model

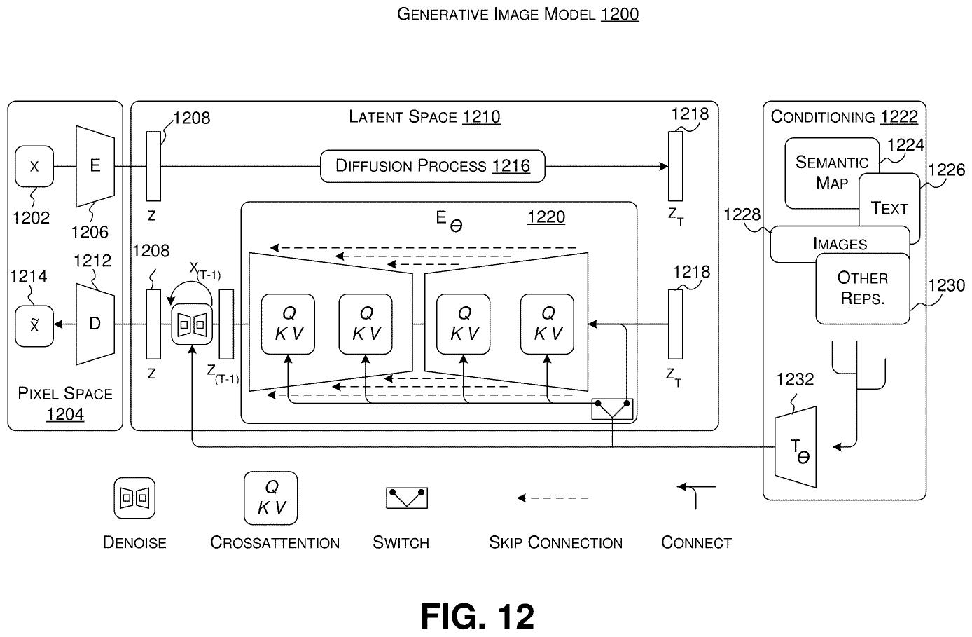

FIG. 12 illustrates an example generative image model 1200. For instance, generative image model 1200 can be implemented as a Stable Diffusion model (Rombach, et al., “High-Resolution Image Synthesis with Latent Diffusion Models,” Proceedings of the IEEE/CVF Conference on Computer Vision and Pattern Recognition, 2022), in which an image 1202 (X) in pixel space 1204 (e.g., red, green, blue) is encoded by an encoder 1206 (E) into a representation 1208 (Z) in a latent space 1210. A decoder 1212 (D) is trained to decode the latent representation Z to produce a reconstructed image 1214 (X~) in the pixel space. For instance, the encoder can be trained (with the decoder) as a variational autoencoder using a reconstruction loss term with a regularization term.

In the latent space 1210, a diffusion process 1216 adds noise to obtain a noisy representation 1218 (Z_{T}). A denoising component 1220 (E_{θ}) is trained to predict the noise in the compressed latent image Z_{T}. The denoising component can include a series of denoising autoencoders implemented using UNet 2D convolutional layers.

The denoising can involve conditioning 1222 on other modalities, such as a semantic map 1224, text 1226, images 1228, or other representations 1230 which can be processed to obtain an encoded representation 1232 (T_{θ}). For instance, text can be encoded using a text encoder (e.g., BERT, CLIP, etc.) to obtain the encoded representation. This encoded representation can be mapped to layers of the denoising component using cross-attention. The result is a text-conditioned latent diffusion model that can be employed to generate images conditioned on text inputs. To train a model such as CLIP, pairs of images and captions can be obtained from a dataset to encode both the images and captions, and the encoder can be trained to represent pairs of images and captions with similar embeddings.

Generative image model 1200 can be employed for text to image generation, where an image is generated from a text prompt. Text prompts can be provided by users or generated automatically by machine learning using the disclosed techniques. In other cases, generative image model 1200 can be employed for image-to-image mode, where an image is generated using an input image as well as a user or machine-generated text prompt. Generative image model 1200 can also be employed for inpainting, where parts of an image are masked and remain fixed while the rest of the image is generated by the model, in some cases conditioned on a user or machine-generated text prompt.

Generative image model 1200 can be guided by a separate network, such as a ControlNet (Zhang, et al., “Adding Conditional Control to Text-to-Image Diffusion Models,” Proceedings of the IEEE/CVF International Conference on Computer Vision, 2023). For instance, a ControlNet can guide the generative model to produce an image that preserves certain aspects of another image, e.g., the spatial layout and salient features of an image prior. A ControlNet can be implemented by locking the parameters of generative image model 1200, cloning the model into another copy. The copy is connected to the original model with one or more zero convolutional layers which are then optimized with the parameters of the copy. For instance, the ControlNet can be trained to preserve edges, lines, boundaries, human poses, semantic segmentations, etc. from an image. A ControlNet can also be trained to preserve depth relationships of a user-identified image using a depth map obtained from the user-identified image, etc. The outputs of a ControlNet can be added to connections within the denoising layer. Thus, the generative image model can produce images that are conditioned not only on text, but also aspects of another image.

Generative image model 1200 can implement a number of different modes. In a text-to-image mode, an image is generated from a given text prompt. In an image-to-image mode, an image is generated from a text prompt and an input image, and the generated image retains features of the input image while introducing new elements or styles consistent with the prompt. In inpainting/outpainting mode, the processing is similar to the image-to-image mode, but an image mask is used to determine which parts of the image are fixed to match the input image. The rest of the image is generated in a way that is consistent with the fixed parts of the image. Note that the term “inpainting,” as used herein, includes filling in parts of a given image whereas “outpainting” refers to extending an image outward.

### Device Implementations

As noted above with respect to FIG. 6, system 600 includes several devices, including a client device 610, a client device 620, a server 630, and a server 640. As also noted, not all device implementations can be illustrated, and other device implementations should be apparent to the skilled artisan from the description above and below.

The term “device,” “computer,” “computing device,” “client device,” and or “server device” as used herein can mean any type of device that has some amount of hardware processing capability and/or hardware storage/memory capability. Processing capability can be provided by one or more hardware processors (e.g., hardware processing units/cores) that can execute computer-readable instructions to provide functionality. Computer-readable instructions and/or data can be stored on storage, such as storage/memory and or the datastore and, when executed, can cause a processor to perform acts. The term “system” as used herein can refer to a single device, multiple devices, etc.

Storage resources can be internal or external to the respective devices with which they are associated. The storage resources can include any one or more of volatile or non-volatile memory, hard drives, solid state drives, flash storage devices, and/or optical storage devices (e.g., CDs, DVDs, etc.), among others. As used herein, the terms “computer-readable media” and “computer-readable medium” can include signals. In contrast, the terms “computer-readable storage media” and “computer-readable storage medium” excludes signals. Computer-readable storage media includes “computer-readable storage devices.” Examples of computer-readable storage devices include volatile storage media, such as RAM, and non-volatile storage media, such as hard drives, optical discs, solid state drives, flash memory, etc.

In some cases, the devices are configured with a general-purpose hardware processor and storage resources. Processors and storage can be implemented as separate components or integrated together as in computational RAM. In other cases, a device can include a system on a chip (SOC) type design. In SOC design implementations, functionality provided by the device can be integrated on a single SOC or multiple coupled SOCs. One or more associated processors can be configured to coordinate with shared resources, such as memory, storage, etc., and/or one or more dedicated resources, such as hardware blocks configured to perform certain specific functionality. Thus, the term “processor,” “hardware processor” or “hardware processing unit” as used herein can also refer to central processing units (CPUs), graphical processing units (GPUs), neural processing units (NPUs), controllers, microcontrollers, processor cores, or other types of processing devices suitable for implementation both in conventional computing architectures as well as SOC designs.

Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc.

In some configurations, any of the modules/code discussed herein can be implemented in software, hardware, and/or firmware. In any case, the modules/code can be provided during manufacture of the device or by an intermediary that prepares the device for sale to the end user. In other instances, the end user may install these modules/code later, such as by downloading executable code and installing the executable code on the corresponding device.

Also note that devices generally can have input and/or output functionality. For example, computing devices can have various input mechanisms such as keyboards, mice, touchpads, voice recognition, gesture recognition (e.g., using depth cameras such as stereoscopic or time-of-flight camera systems, infrared camera systems, RGB camera systems or using accelerometers/gyroscopes, facial recognition, etc.), microphones, etc. Devices can also have various output mechanisms such as printers, monitors, loudspeakers, etc.

Also note that the devices described herein can function in a stand-alone or cooperative manner to implement the described techniques. For example, the methods and functionality described herein can be performed on a single computing device and/or distributed across multiple computing devices that communicate over network(s) 650. Without limitation, network(s) 650 can include one or more local area networks (LANs), wide area networks (WANs), the Internet, and the like.

### ADDITIONAL EXAMPLES

Various examples are described above. Additional examples are described below. One example includes a computer-implemented method comprising obtaining a demonstration video of a demonstration of a particular task by a first entity, obtaining one or more contextual signals associated with the demonstration video, segmenting the demonstration video into multiple video segments based at least on the one or more contextual signals, generating augmentation data associated with individual video segments of the demonstration video using a multi-modal generative model, and storing the augmentation data in a database, the augmentation data in the database providing a basis for subsequent retrieval-automated generation of answers to queries relating to the particular task by a second entity.

Another example can include any of the above and/or below examples where the one or more contextual signals include gaze signals indicating where the first entity directs gaze during the demonstration.

Another example can include any of the above and/or below examples where the segmenting is based at least on tracking one or more objects in the demonstration video based at least on the gaze signals.

Another example can include any of the above and/or below examples where the one or more contextual signals include speech signals indicating words spoken by the first entity during the demonstration.

Another example can include any of the above and/or below examples where the method further comprises prompting the multi-modal generative model to select one or more keyframes for the individual video segments and prompting the multi-modal generative model to generate keyframe captions for the one or more keyframes.

Another example can include any of the above and/or below examples where the method further comprises storing the one or more keyframes and the keyframe captions in the database as the augmentation data.

Another example can include any of the above and/or below examples where the method further comprises determining keyframe embeddings representing the one or more keyframes, determining keyframe caption embeddings representing the captions, and storing the keyframe embeddings and the keyframe caption embeddings in the database.

Another example can include any of the above and/or below examples where the demonstration video shows the particular task being performed from a perspective of the first entity.

Another example includes a computer-implemented method comprising receiving a query relating to performance of a particular task that has been demonstrated by a first entity, the query being received from a second entity, receiving an input image depicting an attempt to perform the particular task by the second entity, accessing a database having augmentation data for individual video segments relating to demonstration of the particular task by the first entity, retrieving, from the database, selected augmentation data based at least on the input image, inputting the selected augmentation data to a multi-modal generative model with a prompt requesting generation of an answer to the query based at least on the selected augmentation data, receiving the generated answer from the multi-modal generative model, and outputting the answer to the second entity.

Another example can include any of the above and/or below examples where the method further comprises receiving one or more contextual signals associated with the second entity and retrieving the selected augmentation data based at least on the one or more contextual signals.

Another example can include any of the above and/or below examples where the one or more contextual signals indicate where the second entity directs gaze

Another example can include any of the above and/or below examples where the method further comprises generating an input image caption for the input image based at least on the one or more contextual signals, where the selected augmentation data is retrieved based at least on the input image caption.

Another example can include any of the above and/or below examples where the method further comprises determining an input image embedding representing the input image and determining an input image caption embedding representing the input image caption, where the retrieving is based at least on the input image embedding and the input image caption embedding.

Another example can include any of the above and/or below examples where the selected augmentation data is retrieved by comparing the input image embedding to keyframe embeddings representing one or more keyframes from the demonstration video.

Another example can include any of the above and/or below examples where the selected augmentation data is retrieved by comparing the input image caption embedding to keyframe caption embeddings representing keyframe captions of the one or more keyframes.

Another example can include any of the above and/or below examples where the first entity and the second entity are human.

Another example can include any of the above and/or below examples where at least one of the first entity or second entity is a robot or other automated entity.

Another example includes a system comprising a processor and a storage medium storing instructions which, when executed by the processor, cause the system to receive a query relating to performance of a particular task that has been demonstrated by a first entity, the query being received from a second entity, receive an input image relating to the query, access a database having augmentation data for individual video segments relating to demonstration of the particular task by the first entity, retrieve, from the database, selected augmentation data based at least on the input image, input the selected augmentation data to a multi-modal generative model, prompt the multi-modal generative model to generate an answer to the query based at least on the selected augmentation data, receive the generated answer from the multi-modal generative model, and output the answer to the second entity.

Another example can include any of the above and/or below examples where the method further comprises one or more cameras configured to capture the input image, one or more microphones configured to capture the query from speech by the second entity, and one or more loudspeakers configured to play back the answer to the second entity.

Another example can include any of the above and/or below examples where the system is embodied as smart glasses.

### CONCLUSION

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and other features and acts that would be recognized by one skilled in the art are intended to be within the scope of the claims.

1. A computer-implemented method comprising:
obtaining a demonstration video of a demonstration of a particular task by a first entity;
obtaining one or more contextual signals associated with the demonstration video;
segmenting the demonstration video into multiple video segments based at least on the one or more contextual signals;
generating augmentation data associated with individual video segments of the demonstration video using a multi-modal generative model; and
storing the augmentation data in a database,
the augmentation data in the database providing a basis for subsequent retrieval-automated generation of answers to queries relating to the particular task by a second entity.

2. The computer-implemented method of claim 1, the one or more contextual signals including gaze signals indicating where the first entity directs gaze during the demonstration.

3. The computer-implemented method of claim 2, the segmenting being based at least on tracking one or more objects in the demonstration video based at least on the gaze signals.

4. The computer-implemented method of claim 1, the one or more contextual signals including speech signals indicating words spoken by the first entity during the demonstration.

5. The computer-implemented method of claim 1, further comprising:
prompting the multi-modal generative model to select one or more keyframes for the individual video segments; and
prompting the multi-modal generative model to generate keyframe captions for the one or more keyframes.

6. The computer-implemented method of claim 5, further comprising:
storing the one or more keyframes and the keyframe captions in the database as the augmentation data.

7. The computer-implemented method of claim 6, further comprising:
determining keyframe embeddings representing the one or more keyframes;
determining keyframe caption embeddings representing the captions; and
storing the keyframe embeddings and the keyframe caption embeddings in the database.

8. The computer-implemented method of claim 1, wherein the demonstration video shows the particular task being performed from a perspective of the first entity.

9. A computer-implemented method comprising:
receiving a query relating to performance of a particular task that has been demonstrated by a first entity, the query being received from a second entity;
receiving an input image depicting an attempt to perform the particular task by the second entity;
accessing a database having augmentation data for individual video segments relating to demonstration of the particular task by the first entity;
retrieving, from the database, selected augmentation data based at least on the input image;
inputting the selected augmentation data to a multi-modal generative model with a prompt requesting generation of an answer to the query based at least on the selected augmentation data;
receiving the generated answer from the multi-modal generative model; and
outputting the answer to the second entity.

10. The computer-implemented method of claim 9, further comprising:
receiving one or more contextual signals associated with the second entity; and
retrieving the selected augmentation data based at least on the one or more contextual signals.

11. The computer-implemented method of claim 10, the one or more contextual signals indicating where the second entity directs gaze.

12. The computer-implemented method of claim 11, further comprising:
generating an input image caption for the input image based at least on the one or more contextual signals,
wherein the selected augmentation data is retrieved based at least on the input image caption.

13. The computer-implemented method of claim 12, further comprising:
determining an input image embedding representing the input image; and
determining an input image caption embedding representing the input image caption,
wherein the retrieving is based at least on the input image embedding and the input image caption embedding.

14. The computer-implemented method of claim 13, wherein the selected augmentation data is retrieved by:
comparing the input image embedding to keyframe embeddings representing one or more keyframes from the demonstration video.

15. The computer-implemented method of claim 14, wherein the selected augmentation data is retrieved by:
comparing the input image caption embedding to keyframe caption embeddings representing keyframe captions of the one or more keyframes.

16. The computer-implemented method of claim 9, wherein the first entity and the second entity are human.

17. The computer-implemented method of claim 9, wherein at least one of the first entity or second entity is a robot or other automated entity.

18. A system comprising:
a processor; and
a storage medium storing instructions which, when executed by the processor, cause the system to:
receive a query relating to performance of a particular task that has been demonstrated by a first entity, the query being received from a second entity;
receive an input image relating to the query;
access a database having augmentation data for individual video segments relating to demonstration of the particular task by the first entity;
retrieve, from the database, selected augmentation data based at least on the input image;
input the selected augmentation data to a multi-modal generative model;
prompt the multi-modal generative model to generate an answer to the query based at least on the selected augmentation data;
receive the generated answer from the multi-modal generative model; and
output the answer to the second entity.

19. The system of claim 18, further comprising:
one or more cameras configured to capture the input image;
one or more microphones configured to capture the query from speech by the second entity; and
one or more loudspeakers configured to play back the answer to the second entity.

20. The system of claim 19, embodied as smart glasses.
